(19) United States
(12) Patent Application Publication
(10) Pub. No.: US 2026/0252988 A1
(43) Pub. Date: Aug. 27, 2026

(54) Supply Chain Networks for Movable Resource Balancing

(71) Applicant: Blue Yonder Group, Inc., Scottsdale, AZ (US)

(72) Inventors: Connie Stehlik, Pewaukee, WI (US); Peter Edward Stubbs, Georgetown, MA (US); Raghuveer Prasad Ngagar, Kota (IN)

(21) Appl. No.: 19/396,763

(22) Filed: Nov. 21, 2025

Related U.S. Application Data
(60) Provisional application No. 63/802,939, filed on May 9, 2025.
(60) Provisional application No. 63/782,887, filed on Apr. 3, 2025.
(60) Provisional application No. 63/770,526, filed on Mar. 12, 2025.
(60) Provisional application No. 63/762,337, filed on Feb. 24, 2025.

(51) Int. Cl. G06Q 10/0631

(52) U.S. Cl. CPC G06Q 10/06315

(57) ABSTRACT

A system and method are disclosed for movable resource balancing. The method includes determining resources of a supply chain facility which are not required after a planned automation implementation, deriving a movable resource which may be used within a supply chain network, determining availability attributes of the movable resource, publishing availability of the movable resource on a global network, selecting a new owner of the movable resource, preparing a dynamic contract for transmitting ownership of the movable resource, and transferring the ownership of the movable resource based on the dynamic contract. The method further includes where the movable resource comprises movable equipment, movable fixtures, robots, computer numerical control machines, tooling, scaffolding and mobile construction equipment and where the availability attributes comprise dates of availability, locations, and a price.

### CROSS-REFERENCE TO RELATED APPLICATIONS

The present disclosure is related to that disclosed in the U.S. Provisional Application No. 63/762,337, filed February 24, 2025, entitled “Supply Chain Networks for Labor Aligning,” U.S. Provisional Application No. 63/770,526, filed March 12, 2025, entitled “Supply Chain Networks for Fixed Resource Balancing,” U.S. Provisional Application No. 63/782,887, filed April 3, 2025, entitled “Supply Chain Networks for Movable Resource Balancing,” and U.S. Provisional Application No. 63/802,939, filed May 9, 2025, entitled “Supply Chain Networks for Transportation Resource Balancing.” U.S. Provisional Application Nos. 63/762,337, 63/770,526, 63/782,887, and 63/802,939 are assigned to the assignee of the present application.

### TECHNICAL FIELD

The present disclosure relates generally to supply chain management and specifically to movable resource balancing.

### BACKGROUND

Demand for products and services offered by companies often vary over time. Such fluctuations in demand impact operating profit, as the cost of using movable resources, such as manufacturing equipment or machinery, warehousing equipment or machinery, logistics or transportation equipment or machinery, and the like, may outweigh the profit gained from using such movable resources during periods of low demand. Existing systems may provide for standard sales of equipment, machinery, and the like for companies to adjust available movable resources to account for fluctuations in demand. However, such methods of adjusting movable resources may result in delays in transfers of ownership of movable resources, leading to increased operating costs and failure to meet demand. Use of existing systems thus results in decreased operating profit, which is undesirable.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 illustrates an example supply chain network, in accordance with a first embodiment;

FIG. 2 illustrates the movable resource balancing system, the archiving system, and the planning and execution system of FIG. 1 in greater detail, in accordance with an embodiment; and

FIG. 3 illustrates an example method for movable resource balancing, in accordance with an embodiment.

### DETAILED DESCRIPTION

Aspects and applications of the invention presented herein are described below in the drawings and detailed description of the invention. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are illustrated or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

As described in further detail below, embodiments of the following systems and methods for movable resource balancing, which may be provided to manage one or more movable resources. Embodiments may detect availability of one or more movable resources of a supply chain facility and determine one or more availability attributes of the derived one or more movable resources. Systems and methods disclosed herein may also publish availability of the one or more derived movable resources on a network and determine a new owner of the movable resource.

Embodiments of the following disclosure may prepare a dynamic contract and change ownership of the movable resource based on the dynamic contract. Use of embodiments may provide for efficient transfers of ownership of movable resources, which may decrease operating costs.

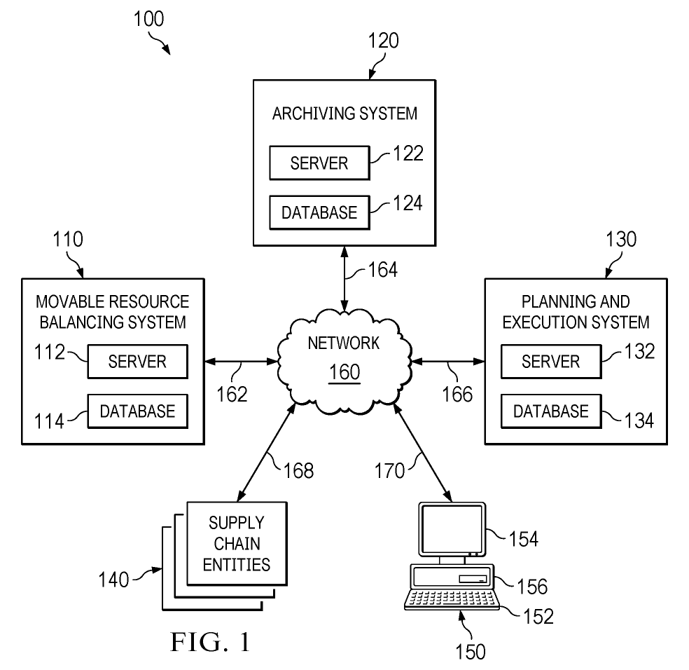

FIG. 1 illustrates supply chain network 100, in accordance with a first embodiment. Supply chain network comprises movable resource balancing system 110, archiving system 120, planning and execution system 130, one or more supply chain entities 140, one or more computers 150, network 160, and one or more communication links 162-170. Although a single movable resource balancing system 110, a single archiving system 120, a single planning and execution system 130, one or more supply chain entities 140, one or more computers 150, a single network 160, and one or more communication links 162-170 are illustrated and described, embodiments contemplate any number of movable resource balancing systems, archiving systems, planning and execution systems, supply chain entities, computers, networks, or communication links, according to particular needs.

In one embodiment, movable resource balancing system 110 comprises server 112 and database 114. Although movable resource balancing system 110 is illustrated in FIG. 1 as comprising a single server 112 and a single database 114, embodiments contemplate movable resource balancing system 110 including any suitable number of servers, databases, serverless computing options, or data stores internal to, or externally coupled with, movable resource balancing system 110, according to particular needs. For the purposes of this disclosure, all instances of “server” are understood to include, according to embodiments, one or more embodiments of servers, serverless computing options, and/or other computing solutions, and all instances of “database” are understood to include, according to embodiments, databases, datastores, data stores, and/or other data storage systems, according to particular needs. As used herein, the word “customer” includes individual shoppers or consumers such as humans or automated machines or bots, business or organizational clients, and/or any other person, machine, or entity that may place an order for goods or services. In embodiments, movable resource balancing system 110 provides movable resource balancing by detecting availability of a movable resource in supply chain network 100. As discussed in further detail below, movable resource balancing system 110 may determine availability attributes of the movable resource and publish availability of the movable resource on a network. Further, movable resource balancing system 110 may determine a new owner of the movable resource, prepare a contract, and transfer ownership of the movable resource based on the contract agreement.

Archiving system 120 comprises server 122 and database 124. Although archiving system 120 is illustrated as comprising a single server 122 and a single database 124, embodiments contemplate any suitable number of servers or databases internal to, or externally coupled with, archiving system 120. Server 122 of archiving system 120 may support one or more processes for receiving and storing data from planning and execution system 130 and/or one or more computers 150 of supply chain network 100. According to some embodiments, archiving system 120 comprises an archive of data received from planning and execution system 130 and/or one or more computers 150 and provides archived data to movable resource balancing system 110 and/or planning and execution system 130. Server 122 may store the received data in database 124, which may comprise one or more databases or other data storage arrangements at one or more locations local to, or remote from, server 122.

According to an embodiment, planning and execution system 130 comprises server 132 and database 134. Supply chain planning and execution is typically performed by several distinct and dissimilar processes, including, for example, order promising, assortment planning, demand planning, operations planning, production planning, supply planning, distribution planning, execution, pricing, forecasting, transportation management, warehouse management, inventory management, fulfillment, procurement, and the like. Server 132 of planning and execution system 130 comprises one or more modules, such as, for example, an order promising module, a sourcing module, a scheduling module, and/or a pick-pack-ship module for performing one or more order fulfillment processes. Server 132 stores and retrieves data from database 134 or one or more locations in supply chain network 100. In addition, planning and execution system 130 operates on one or more computers 150 that are integral to, or separate from, the hardware and/or software that support archiving system 120 and movable resource balancing system 110.

One or more supply chain entities 140 may represent one or more suppliers, manufacturers, distribution centers, and retailers in supply chain network 100, including one or more enterprises. One or more suppliers may be any suitable entity that offers to sell or otherwise provides one or more items or components to one or more manufacturers or buyers. One or more suppliers may, for example, receive an item from a first supply chain entity of one or more supply chain entities 140 in supply chain network 100 and provide the item to another supply chain entity of one or more supply chain entities 140, which in some embodiments may be a buyer, a customer, or an end user. Items may comprise, for example, components, materials, products, parts, supplies, or other items that may be used to produce products. In addition, or as an alternative, an item may comprise a supply or resource that is used to manufacture the item but does not become a part of the item. In embodiments, items may comprise a service, such as an installation service. One or more suppliers may comprise automated distribution systems that automatically transport items to one or more manufacturers based, at least in part, on a supply chain plan having fair-shared items or resources, a material or capacity reallocation, current and projected inventory levels, and/or one or more additional factors described herein.

One or more manufacturers may be any suitable entity that manufactures at least one product. One or more manufacturers may use one or more items during the manufacturing process to produce any manufactured, fabricated, assembled, or otherwise processed item, material, component, good or product. In one embodiment, a product represents an item ready to be supplied to, for example, another supply chain entity, such as a supplier, an item that needs further processing, or any other item. One or more manufacturers may, for example, produce and sell a product to a supplier, another manufacturer, a distribution center, a retailer, a customer, or any other suitable person or entity. Such manufacturers may comprise automated robotic production machinery that produce products based, at least in part, on a supply chain plan having fair-shared items or resources, a material or capacity reallocation, current and projected inventory levels, and/or one or more additional factors described herein.

One or more distribution centers may be any suitable entity that offers to sell or otherwise distributes at least one product to one or more retailers and/or customers. One or more distribution centers may, for example, receive a product from a first supply chain entity of one or more supply chain entities 140 in supply chain network 100 and store and transport the product for a second supply chain entity of one or more supply chain entities 140. Such distribution centers may comprise automated warehousing systems that automatically transport products to one or more retailers or customers and/or automatically remove an item from, or place an item into, inventory based, at least in part, on a supply chain plan having fair-shared items or resources, a material or capacity reallocation, current and projected inventory levels, and/or one or more additional factors described herein.

One or more retailers may be any suitable entity that obtains one or more products to sell to one or more customers. In addition, one or more retailers may sell, store, and supply one or more components and/or repair a product with one or more components. One or more retailers may comprise any online or brick and mortar location, including locations with shelving systems. Shelving systems may comprise, for example, various racks, fixtures, brackets, notches, grooves, slots, or other attachment devices for fixing shelves in various configurations. These configurations may comprise shelving with adjustable lengths, heights, and other arrangements, which may be adjusted by an employee of one or more retailers based on computer-generated instructions or automatically by machinery to place products in a desired location.

The same supply chain entity may simultaneously act as any one or more suppliers, one or more manufacturers, one or more distribution centers, and one or more retailers. For example, one or more supply chain entities 140 acting as a manufacturer may produce a product, and the same one or more supply chain entities 140 may act as a supplier to supply a product to another one or more supply chain entities 140. Although one example of supply chain network 100 is illustrated and described, embodiments contemplate any configuration of supply chain network 100 without departing from the scope of the present disclosure.

As illustrated in FIG. 1, supply chain network 100 comprising movable resource balancing system 110, archiving system 120, planning and execution system 130, and one or more supply chain entities 140 may operate on one or more computers 150 that are integral to, or separate from, the hardware and/or software that support movable resource balancing system 110, archiving system 120, planning and execution system 130, and one or more supply chain entities 140. One or more computers 150 may include any suitable input device 152, such as a keypad, mouse, touch screen, microphone, or other device to input information. Output device 154 one or more computers 150 may convey information associated with the operation of supply chain network 100, including digital or analog data, visual information, or audio information. One or more computers 150 may include movable or removable computer-readable storage media, including a non-transitory computer-readable medium, magnetic computer disks, flash drives, CD-ROM, in-memory device, or other suitable media to receive output from and provide input to supply chain network 100.

One or more computers 150 may further include one or more processors 156 and associated memory to execute instructions and manipulate information according to the operation of supply chain network 100 and any of the methods described herein. In addition, or as an alternative, embodiments contemplate executing the instructions on one or more computers 150 that cause one or more computers 150 to perform functions of the methods. An apparatus implementing special purpose logic circuitry, such as, for example, one or more field-programmable gate arrays (FPGA) or application-specific integrated circuits (ASIC), may perform functions of the methods described herein. Further examples may also include articles of manufacture comprising tangible non-transitory computer-readable media that have computer-readable instructions encoded thereon, and the instructions may comprise instructions to perform functions of the methods described herein.

In addition, or as an alternative, supply chain network 100 may comprise a cloud-based computing system having processing and storage devices at one or more locations local to, or remote from, movable resource balancing system 110, archiving system 120, planning and execution system 130, and one or more supply chain entities 140. In addition, each of one or more computers 150 may be a workstation, personal computer (PC), network computer, notebook computer, tablet, personal digital assistant (PDA), cell phone, telephone, smartphone, wireless data port, augmented or virtual reality headset, or any other suitable computing device. In an embodiment, one or more users may be associated with movable resource balancing system 110 and archiving system 120.

In one embodiment, movable resource balancing system 110 may be coupled with network 160 using communication link 162, which may be any wireline, wireless, or other link suitable to support data communications between movable resource balancing system 110 and network 160 during operation of supply chain network 100. Archiving system 120 may be coupled with network 160 using communication link 164, which may be any wireline, wireless, or other link suitable to support data communications between archiving system 120 and network 160 during operation of supply chain network 100. Planning and execution system 130 may be coupled with network 160 using communication link 166, which may be any wireline, wireless, or other link suitable to support data communications between planning and execution system 130 and network 160 during operation of supply chain network 100. One or more supply chain entities 140 may be coupled with network 160 using communication link 168, which may be any wireline, wireless, or other link suitable to support data communications between one or more supply chain entities 140 and network 160 during operation of supply chain network 100. One or more computers 150 may be coupled with network 160 using communication link 170, which may be any wireline, wireless, or other link suitable to support data communications between one or more computers 150 and network 160 during operation of supply chain network 100. Although communication links 162-170 are illustrated as generally coupling movable resource balancing system 110, archiving system 120, planning and execution system 130, one or more supply chain entities 140, and one or more computers 150 to network 160, any of movable resource balancing system 110, archiving system 120, planning and execution system 130, one or more supply chain entities 140, and one or more computers 150 may communicate directly with each other, according to particular needs.

In another embodiment, the network includes the Internet and any appropriate local area networks (LANs), metropolitan area networks (MANs), or wide area networks (WANs) coupling movable resource balancing system 110, archiving system 120, planning and execution system 130, one or more supply chain entities 140, and one or more computers 150. For example, data may be maintained locally to, or externally of, movable resource balancing system 110, archiving system 120, planning and execution system 130, one or more supply chain entities 140, and one or more computers 150 and made available to one or more associated users of movable resource balancing system 110, archiving system 120, planning and execution system 130, one or more supply chain entities 140, and one or more computers 150 using network 160 or in any other appropriate manner. For example, data may be maintained in a cloud database at one or more locations external to movable resource balancing system 110, archiving system 120, planning and execution system 130, one or more supply chain entities 140, and one or more computers 150 and made available to one or more associated users of movable resource balancing system 110, archiving system 120, planning and execution system 130, one or more supply chain entities 140, and one or more computers 150 using the cloud or in any other appropriate manner. Those skilled in the art will recognize that the complete structure and operation of network 160 and other components within supply chain network 100 are not depicted or described. Embodiments may be employed in conjunction with known communications networks and other components.

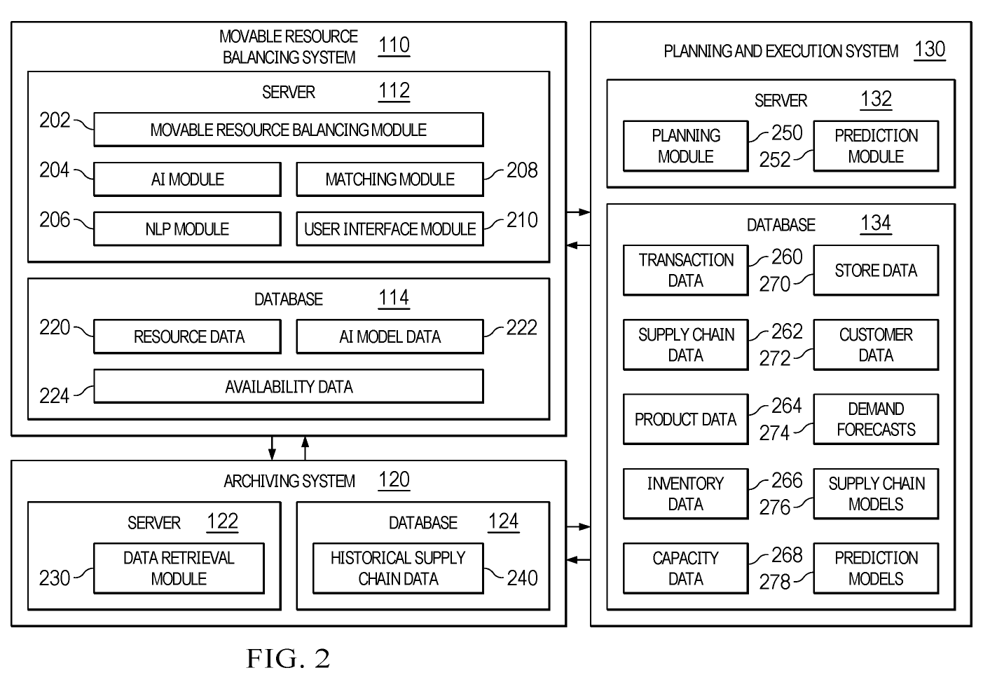

FIG. 2 illustrates movable resource balancing system 110, archiving system 120, and planning and execution system 130 of FIG. 1 in greater detail, in accordance with an embodiment. Movable resource balancing system 110 may comprise server 112 and database 114, as described above. Although movable resource balancing system 110 is illustrated as comprising a single server 112 and a single database 114, embodiments contemplate any suitable number of servers or databases internal to, or externally coupled with, movable resource balancing system 110.

Server 112 of movable resource balancing system 110 comprises movable resource balancing module 202, artificial intelligence (AI) module 204, natural language processing (NLP) module 206, matching module 208, and user interface module 210. Although server 112 is illustrated and described as comprising a single movable resource balancing module 202, a single AI module 204, a single NLP module 206, a single matching module 208, and a single user interface module 210, embodiments contemplate any suitable number or combination of these located at one or more locations local to, or remote from, movable resource balancing system 110, such as on multiple servers or one or more computers 150 at one or more locations in supply chain network 100.

In an embodiment, movable resource balancing module 202 may be configured to provide any data processing and/or data handling necessary to provide movable resource balancing, such as, for example, by providing one or more necessary services and/or functionalities. In some embodiments, a movable resource may comprise any resource that may be related and/or associated with one or more supply chain operations, such as, for example, any kind of manufacturing equipment and/or machinery, any kind of warehousing equipment and/or machinery, any kind of logistics and/or transportation facility, and the like. In other embodiments, a movable resource may also comprise a resource that is not part of supply chain network 100 per se and/or does not per se provide supply chain functionality, such as, for example, medical equipment, entertainment equipment, maintenance equipment, educational equipment, and the like. Embodiments further contemplate that movable resources may or may not be moved between facilities to optimize one or more supply chain facilities, according to particular needs. Movable resource balancing module 202 may coordinate the operation of each of the modules of movable resource balancing system 110, as described in further detail below. According to embodiments, movable resource balancing module 202 provides a front-end and/or portal through which users may access one or more services and/or functionalities provided by movable resource balancing system 110. Movable resource balancing module 202 may further execute one or more workflows that coordinates the operation of one or more other modules and/or one or more external systems. By way of example only and not by way of limitation, movable resource balancing module 202 may execute a workflow that coordinates a search received via user interface module 210 with matching module 208, where matching module 208 utilizes AI model results provided by AI module 204. In some embodiments, movable resource balancing module 202 may be configured to be accessible only within a particular organization and/or company, though other embodiments contemplate that movable resource balancing module 202 may be configured to be accessible by more than one organization and/or company such as through a single global network, according to particular needs. Movable resource balancing module 202 may further provide any kind of role-based access (RBAC) and/or permissions for one or more users accessing movable resource balancing system 110. For example, a user accessing movable resource balancing system 110 to search for available movable resources may have different access permission(s) than an officer of a company who may be authorized to execute a purchase and/or lease agreement for a movable resource. Movable resource balancing module 202 may also publish availability of the movable resource on a network, as described in further detail below.

In an embodiment, AI module 204 may comprise one or more AI engines which may use one or more machine learning (ML) and/or AI models that provide modelling of any characteristic of a movable resource. AI module 204 may utilize any ML and/or AI model, such as, for example, one or more reinforcement learning models, large language models (LLMs), classification models, segmentation models, decision trees, and/or the like. By way of example only and not by way of limitation, AI module 204 may apply one or more ML and/or AI models to data associated with a particular movable resource to determine and/or predict when the particular movable resource is to be available. According to embodiments, AI module 204 may make a prediction regarding a particular movable resource based on any data associated with the particular movable resource, including capability and/or capacity, model number, fuel type, a location of the particular movable resource, and the like. For example, AI module 204 may make one or more predictions that a particular movable resource is to be available based on capacity utilization, shipments to and/or from a facility, contract data of the movable resource, publicly available data, and/or the like.

Embodiments contemplate that AI module 204 may be trained by historical data associated with one or more movable resources, where the historical data is associated with utilization of the one or more movable resources. By way of example only and not by way of limitation, AI module 204 may determine a facility with low capacity utilization and/or low product shipments as having one or more movable resources that are not being utilized and may be available for sale and/or rent. As another example, AI module 204 may use delayed maintenance for a movable resource to determine that the movable resource is not being utilized and may be available for sale and/or rent. AI module 204 may also trigger an alert based on one or more analyses and/or predictions as described herein, such as, for example, to provide an indication that a particular resource may be currently available and/or is expected be available at a predicted time in the future. Embodiments contemplate that AI module 204 may provide one or more indications and/or alerts, for example, to a manager and/or authorized user who may respond to the one or more indications and/or alerts to confirm or not confirm that a particular movable resource is available for listing in movable resource balancing system 110. Embodiments further contemplate that AI module 204 may assist matching module 208 by providing an intelligent search to match one or more requirements with one or more available movable resources. In addition, or as an alternative, AI module 204 may use historical data and pattern identification to match a best fit movable resource to an available listing when multiple matching movable resources are available.

In an embodiment, NLP module 206 may implement natural language phrases related to information needs, customer input, verbal interaction with a worker and/or supply chain user, and the like. NLP module 206 may be applied to any interaction with movable resource balancing system 110, such as, for example, when a manager and/or user interacts with movable resource balancing system 110 to access and/or view one or more movable resources. Embodiments contemplate that NLP module 206 may receive any kind of command and/or inquiry from a user, for example, by a manager entering an inquiry to review one or more available movable resources. NLP module 206 may further be applied to input in specifying any data for characterizing a movable resource, such as, for example, data characterizing an availability date, type of movable resource, location, and the like, as well as to any input in any format (e.g., text, audio, video, etc.) for providing feedback and/or communication to any of the modules and/or supply chain systems described herein, for example, to receive and process input for providing feedback to AI module 204. In embodiments, NLP module 206 may also provide transcription of any video and/or audio, such as, for example, from a user characterizing a movable resource, a video of the movable resource, and the like, for processing and/or analysis as described elsewhere herein.

In an embodiment, matching module 208 provides any kind of matching between data characterizing and/or describing one or more movable resources and data characterizing and/or describing a search for one or more movable resources. Matching module 208 may receive any kind of criteria entered by a user to perform a matching between a desired movable resource and one or more potential and/or available movable resources. In embodiments, matching module 208 provides a ranked list of available movable resources that match any criteria, such as, for example, that match a location, a type of movable resource, a cost or price, and/or the like. Embodiments contemplate that matching module 208 may utilize any kind of pattern matching model and/or algorithm from AI module 204 to match one or more desired characteristics and/or attributes with one or more movable resources, as well as to search for one or more movable resources. For example, matching module 208 may interact with AI module 204 to identify one or more movable resources, for example, by utilizing a model such as a decision tree that provides for identifying one or more movable resources that match one or more requirements. Matching module 208 may be accessible according to any scheme and/or communications architecture, such as, for example, through a company intranet, through the Internet, through a single global network, and the like. Matching module 208 may also provide any kind of market clearing mechanism to match a movable resource with a party, for example, by allocating the movable resource to whichever party first initiates an inquiry, by requesting bids over a time period, by an auction system, and the like. In embodiments, matching module 208 may be accessed according to any role and/or permissions scheme, for example, to provide a lower level worker with access to searching for movable resources, to provide management with access for executing a sales and/or lease contract for a particular movable resource, and the like. Matching module 208 may interface with any external websites (e.g., online equipment auctions and/or listings, etc.) to search external listings and/or provide external access for searching for any movable resource within movable resource balancing system 110.

In an embodiment, user interface module 210 generates and displays a user interface (UI), such as, for example, a graphical user interface (GUI), that displays movable resource balancing data or any other data of movable resource balancing system 110 in charts, graphs, histograms, or any other visual representations. According to embodiments, user interface module 210 displays a GUI comprising interactive graphical elements interacting with any operation of movable resource balancing system 110, such as, for example, to enter data to search for available movable resources, to enter any kind of availability data 224 characterizing a movable resource, and/or the like. In addition, or as an alternative, user interface module 210 may generate non-visual interfaces, such as voice-based digital assistants, email messages, or other text-based messages, and present any data of movable resource balancing system 110 over such non-visual interfaces. Embodiments further contemplate that user interface module 210 may comprise an agentic AI user interface and present data of movable resource balancing system 110 over such agentic AI user interfaces on an output device associated with supply chain network 100, such as, for example, output device 154 of one or more computers 150.

In embodiments, any module of movable resource balancing system 110 may communicate with any other module of movable resource balancing system 110 and/or with any supply chain system, for example, by using one or more application programming interfaces (APIs), by using extensible markup language (XML), and/or the like. Embodiments contemplate that movable resource balancing system 110 may operate in a fault-tolerant manner and also may provide error handling procedures. For example, when matching module 208 cannot find any movable resource matching one or more criteria, matching module 208 may relax criteria used in the matching to find movable resources similar to criteria entered into movable resource balancing system 110. In embodiments, movable resource balancing system 110 may be scalable in operation, such as, for example, when movable resource balancing system 110 is implemented for a single company. However, embodiments contemplate that movable resource balancing system 110 may be implemented across many companies and/or large corporations, for example, by providing a single global network that one or more companies may access for movable resource balancing. Embodiments further contemplate that movable resource balancing system 110 may interact with supply chain systems and/or external systems in a robust and fault-tolerant manner, for example, to handle any connectivity issues by adjusting connectivity timeout thresholds, configuring a persistence.xml file, and/or the like.

Database 114 of movable resource balancing system 110 may comprise one or more databases or other data storage arrangements at one or more locations local to, or remote from, server 112. Database 114 of movable resource balancing system 110 comprises, for example, resource data 220, AI model data 222, and availability data 224. Although database 114 is illustrated and described as comprising resource data 220, AI model data 222, and availability data 224, embodiments contemplate any suitable number or combination of data located at one or more locations local to, or remote from, movable resource balancing system 110, according to particular needs. In embodiments, database 114 may comprise any kind of table normalization approach to handle the storage of any kind of data storage formats, for example, for text, images, video, and the like.

In an embodiment, resource data 220 may comprise any data used to characterize a movable resource. For example, resource data 220 may comprise any kind of equipment data and/or machinery data, such as type of movable resource, capacity of movable resource, required fuel and/or energy source, model number, which facility or facilities a movable resource is located, which facilities a movable resource is moved between, and/or the like. In embodiments, resource data 220 may also comprise any kind of equipment capability provided by a movable resource, such as, for example, a particular manufacturing capability (e.g., light manufacturing, machining, electronic packaging, specialty chemicals manufacturing, etc.), a particular lifting and/or carrying capability (e.g., robot carrying capacity, lifting capacity, reach capacity, etc.), and the like. Resource data 220 may further comprise data characterizing and/or describing any kind of non-supply chain movable resource, such as, for example, entertainment equipment (e.g., seats, tables, food preparation equipment, etc.), educational equipment (e.g., projection equipment, electronic teaching aids, etc.), medical equipment (e.g., diagnostic equipment, treatment equipment, equipment related to patient care such as hospital best, etc.), and/or the like.

In an embodiment, AI model data 222 comprises any data for characterizing and/or describing one or more AI and/or ML models. The one or more AI and/or ML models may comprise any type of model, such as, for example, an LLM, a classification model, a segmentation model, a decision tree, a reinforcement learning model, and/or the like. According to embodiments, AI model data 222 may be organized according to any kind of versioning and/or historical tracking of models, for example, to document how AI module 204 has improved and/or refined a model over time. AI model data 222 may comprise different kinds of data sets, such as, for example, a training data set for training an AI model and a corresponding testing and/or evaluation data set for evaluating accuracy, precision, and/or repeatability of the trained AI model. In embodiments, AI model data 222 may reflect different models used for different regions, different companies, different kinds of movable resources, and/or the like, according to particular needs. Embodiments further contemplate that AI model data 222 may comprise any kind of performance data for an AI model, for example, accuracy, precision, error measurements, and the like. AI model data 222 may further comprise one or more scenarios associated with one or more what-ifs as applied to a movable resource balancing. In embodiments, AI model data 222 may characterize any kind of AI model used to predict and/or determine that a movable resource is available and/or that a movable resource is predicted to be available at a particular time, as well as any data used for training one or more AI models for predicting and/or characterizing a particular movable resource, such as, for example, publicly available information (e.g., a press release indicating future availability of a movable resource available, such as a notification of plant closings), contract data (e.g., an expiration date of a contract and/or lease that indicates that a network participant may no longer be utilizing the movable resource), and/or the like.

In an embodiment, availability data 224 may comprise any data characterizing and/or describing availability of a movable resource. For example, availability data 224 may comprise data describing timing associated with availability, such as, for example, a start date that a movable resource is expected to be available, a duration a movable resource is expected to be available, and the like. Embodiments contemplate availability data 224 including any kind of contract and/or agreement for acquiring a movable resource, such as, for example, a sales contract, a lease agreement, terms for acquiring a facility, and the like. By way of example only and not by way of limitation, availability data 224 may comprise any kind of contract and/or lease template for acquiring a moveable resource. Embodiments further contemplate that a contract and/or lease agreement may include any kind of payment and/or compensation mechanism for utilization and/or ownership of the movable resource. In such embodiments, the compensation mechanism may comprise any kind of payment mechanism, such as, for example, monthly mortgage payments, monthly lease payments, payments according to a smart contract and/or distributed ledger, and the like. Movable resource balancing system 110 may receive availability data 224 via manual entry via user interface module 210, such as, for example, by a manager or other user. In addition, or as an alternative, movable resource balancing system 110 may determine availability data 224 by utilizing one or more AI models, as discussed in greater detail above. In embodiments, availability data 224 may also comprise alert data indicating and/or characterizing an availability of a resource.

As discussed above, archiving system 120 comprises server 122 and database 124. Although archiving system 120 is illustrated as comprising a single server 122 and a single database 124, embodiments contemplate any suitable number of servers or databases internal to, or externally coupled with, archiving system 120.

Server 122 of archiving system 120 comprises data retrieval module 230. Although server 122 is illustrated and described as comprising a single data retrieval module 230, embodiments contemplate any suitable number or combination of data retrieval modules located at one or more locations local to, or remote from, archiving system 120, such as on multiple servers or one or more computers 150 at one or more locations in supply chain network 100.

In one embodiment, data retrieval module 230 of archiving system 120 receives historical supply chain data 240 from planning and execution system 130 and one or more supply chain entities 140 and stores received historical supply chain data 240 in archiving system 120 database 124. According to one embodiment, data retrieval module 230 may prepare historical supply chain data 240 for use as training data by checking historical supply chain data 240 for errors and transforming historical supply chain data 240 to normalize, aggregate, and/or rescale historical supply chain data 240 to enable direct comparison of data received from planning and execution system 130, one or more supply chain entities 140, and/or one or more other locations local to, or remote from, archiving system 120. According to embodiments, data retrieval module 230 may receive data from one or more sources external to supply chain network 100, such as, for example, weather data, special events data, social media data, calendar data, and the like, and store the received data as historical supply chain data 240.

Database 124 of archiving system 120 may comprise one or more databases or other data storage arrangements at one or more locations local to, or remote from, server 122. Database 124 of archiving system 120 comprises, for example, historical supply chain data 240. Although database 124 of archiving system 120 is illustrated and described as comprising historical supply chain data 240, embodiments contemplate any suitable number or combination of data located at one or more locations local to, or remote from, archiving system 120, according to particular needs.

Historical supply chain data 240 comprises historical data received from movable resource balancing system 110, planning and execution system 130, one or more supply chain entities 140, and/or one or more computers 150. Historical supply chain data 240 may comprise, for example, weather data, special events data, social media data, calendar data, and the like. In an embodiment, historical supply chain data 240 may comprise, for example, historic sales patterns, prices, promotions, weather conditions, and other factors influencing future demand of the number of one or more items sold in one or more stores over a time period, such as, for example, one or more days, weeks, months, or years, including, for example, a day of the week, a day of the month, a day of the year, a week of the month, a week of the year, a month of the year, special events, paydays, and the like.

As discussed above, planning and execution system 130 comprises server 132 and database 134. Although planning and execution system 130 is illustrated as comprising a single server 132 and a single database 134, embodiments contemplate any suitable number of servers or databases internal to, or externally coupled with, planning and execution system 130.

In embodiments, server 132 of planning and execution system 130 comprises planning module 250 and prediction module 252. Although server 132 is illustrated and described as comprising a single planning module 250 and a single prediction module 252, embodiments contemplate any suitable number or combination of planning modules and prediction modules located at one or more locations local to, or remote from, planning and execution system 130, such as on multiple servers or one or more computers 150 at one or more locations in supply chain network 100.

Planning module 250 of planning and execution system 130 works in connection with prediction module 252 to generate a plan based on one or more predicted retail volumes, classifications, or other predictions. By way of example and not of limitation, planning module 250 may comprise a demand planner that generates a demand forecast for one or more supply chain entities 140. Planning module 250 may generate the demand forecast, at least in part, from predictions and calculated factor values for one or more causal factors received from prediction module 252. By way of a further example, planning module 250 may comprise an assortment planner and/or a segmentation planner that generates product assortments that match causal effects calculated for one or more customers or products by prediction module 252, which may provide for increased customer satisfaction and sales, as well as reduce costs for shipping and stocking products at stores where they are unlikely to sell.

Prediction module 252 of planning and execution system 130 applies samples of transaction data 260, supply chain data 262, product data 264, inventory data 266, capacity data 268, store data 270, customer data 272, demand forecasts 274, and other data to prediction models 278 to generate predictions and calculated factor values for one or more causal factors. Prediction module 252 of planning and execution system 130 may predict a volume Y (target) from a set of causal factors X along with causal factors strengths that describe the strength of each causal factor variable contributing to the predicted volume. According to some embodiments, prediction module 252 generates predictions at daily intervals. However, embodiments contemplate longer and shorter prediction phases that may be performed, for example, weekly, twice a week, twice a day, hourly, or the like. Embodiments further contemplate that prediction module 252 may provide predictions utilized by AI module 204 of movable resource balancing system 110 to predict and/or forecast an availability of a movable resource.

Database 134 of planning and execution system 130 may comprise one or more databases or other data storage arrangements at one or more locations local to, or remote from, server 132. Database 134 of planning and execution system 130 comprises, for example, transaction data 260, supply chain data 262, product data 264, inventory data 266, capacity data 268, store data 270, customer data 272, demand forecasts 274, supply chain models 276, and prediction models 278. Although database 134 of planning and execution system 130 is illustrated and described as comprising transaction data 260, supply chain data 262, product data 264, inventory data 266, capacity data 268, store data 270, customer data 272, demand forecasts 274, supply chain models 276, and prediction models 278, embodiments contemplate any suitable number or combination of data located at one or more locations local to, or remote from, planning and execution system 130, according to particular needs.

Transaction data 260 of planning and execution system 130 may comprise recorded sales and returns transactions and related data, including, for example, a transaction identification, time and date stamp, channel identification (such as stores or online touchpoints), product identification, actual cost, selling price, sales volume, customer identification, promotions, and/or the like. In addition, transaction data 260 is represented by any suitable combination of values and dimensions, aggregated or disaggregated, such as, for example, sales per week, sales per week per location, sales per day, sales per day per season, or the like.

Supply chain data 262 may comprise any data of one or more supply chain entities 140 including, for example, item data, identifiers, metadata (comprising dimensions, hierarchies, levels, members, attributes, cluster information, and member attribute values), fact data (comprising measure values for combinations of members), business constraints, goals, and objectives of one or more supply chain entities 140.

Product data 264 of database 134 may comprise products identified by, for example, a product identifier (such as a SKU, Universal Product Code (UPC), or the like) and one or more attributes and attribute types associated with the product ID. Product data 264 may comprise data about one or more products organized and sortable by, for example, product attributes, attribute values, product identification, product components, sales volume, demand forecast, or any stored category or dimension. Attributes of one or more products may be, for example, any categorical characteristic, structural characteristic, or quality of a product, and an attribute value may be a specific value or identity for the one or more products according to the categorical characteristic or quality, including, for example, physical parameters (such as, for example, size, weight, dimensions, color, and the like).

Inventory data 266 of database 134 may comprise any data relating to current or projected inventory quantities or states, order rules, or the like. For example, inventory data 266 may comprise the current level of inventory for each item at one or more stocking points across supply chain network 100. In addition, inventory data 266 may comprise order rules that describe one or more rules or limits on setting an inventory policy, including, but not limited to, a minimum order volume, a maximum order volume, a discount, and a step-size order volume, and batch quantity rules. According to some embodiments, planning and execution system 130 accesses and stores inventory data 266 in database 134, which may be used by planning and execution system 130 to place orders, set inventory levels at one or more stocking points, initiate manufacturing of one or more components, or the like.

In embodiments, inventory data 266 may also comprise one or more inventory policies. The inventory policies may comprise any suitable inventory policy describing the reorder point and target quantity, or other inventory policy parameters that set rules for planning and execution system 130 to manage and reorder inventory. The inventory policies may be based on target service level, demand, cost, fill rate, or the like. According to embodiments, the inventory policies comprise target service levels that ensure that a service level of one or more supply chain entities 140 is met with a set probability. For example, one or more supply chain entities 140 may set a service level at 95%, meaning one or more supply chain entities 140 sets the desired inventory stock level at a level that meets demand 95% of the time. Although a particular service level target and percentage is described, embodiments contemplate any service target or level, such as, for example, a service level of approximately 99% through 90%, a 75% service level, or any suitable service level, according to particular needs. Other types of service levels associated with inventory quantity or order quantity may comprise, but are not limited to, a maximum expected backlog and a fulfillment level. Once the service level is set, planning and execution system 130 may determine a replenishment order according to one or more replenishment rules, which, among other things, indicates to one or more supply chain entities 140 to determine or receive inventory to replace the depleted inventory. By way of example only and not by way of limitation, an inventory policy for non-perishable goods with linear holding and shorting costs comprises a min./max. (s,S) inventory policy. Other inventory policies may be used for perishable goods, such as fruit, vegetables, dairy, and fresh meat, as well as electronics, fashion, and similar items for which demand drops significantly after a next generation of electronic devices or a new season of fashion is released.

Capacity data 268 of database 134 may comprise any data relating to current or projected resource capacity values or states, order rules, or the like. For example, capacity data 268 may comprise the current level of capacity for each task at one or more locations across supply chain network 100. In addition, capacity data 268 may comprise order rules that describe one or more rules or limits on setting a capacity policy, including, but not limited to, a minimum order capacity, a maximum order capacity, a discount, a step-size order capacity, and batch quantity rules. According to some embodiments, planning and execution system 130 accesses and stores capacity data 268 in database 134, which may be used by planning and execution system 130 to place orders, set capacity levels at one or more locations in supply chain network 100, initiate manufacturing of one or more components, or the like.

In embodiments, capacity data 268 may include one or more capacity policies. The capacity policies may comprise any suitable capacity policy describing the reorder point and target quantity, or other capacity policy parameters that set rules for planning and execution system 130 to manage capacity. The capacity policies may be based on target service level, demand, cost, or the like. According to embodiments, the capacity policies comprise target service levels that ensure that a service level of one or more supply chain entities 140 is met with a set probability. For example, one or more supply chain entities 140 may set a service level at 95%, meaning one or more supply chain entities 140 sets the desired capacity level at a level that meets demand 95% of the time.

Store data 270 may comprise data describing the stores of one or more retailers and related store information. Store data 270 may comprise, for example, a store ID, store description, store location details, store location climate, store type, store opening date, lifestyle, store area (expressed in, for example, square feet, square meters, or other suitable measurement), latitude, longitude, store layouts, employee data for stores, planograms for merchandising with stores, and other similar data.

Customer data 272 of planning and execution system 130 may comprise customer identity information, including, for example, customer relationship management data, loyalty programs, and mappings between product purchases and one or more customers so that a customer associated with a transaction may be identified. Customer data 272 may further comprise data relating customer purchases to one or more products, geographical regions, store locations, or other types of dimensions.

Demand forecasts 274 of database 134 may indicate expected future demand based on, for example, any data relating to past sales, past demand, purchase data, promotions, events, or the like of one or more supply chain entities 140. Demand forecasts 274 may cover a time interval such as, for example, by the minute, by the hour, daily, weekly, monthly, quarterly, yearly, or any other suitable time interval, including substantially in real time. In some embodiments, demand may be modeled as a negative binomial or Poisson-Gamma distribution. According to other embodiments, the model also takes into account shelf-life of perishable goods (which may range from days (e.g., fresh fish or meat) to weeks (e.g., butter) or even months, before any unsold items have to be written off as waste) as well as influences from promotions, price changes, rebates, coupons, and even cannibalization effects within an assortment range. In addition, customer behavior is not uniform but varies throughout the week and is influenced by seasonal effects and the local weather, as well as many other contributing factors. Accordingly, even when demand generally follows a Poisson-Gamma model, the exact values of the parameters of the model may be specific to a single product to be sold on a specific day in a specific location or sales channel and may depend on a wide range of frequently changing influencing causal factors. By way of example only and not by way of limitation, an exemplary supermarket may stock twenty thousand items at one thousand locations. When each location of this exemplary supermarket is open every day of the year, planning and execution system 130 needs to calculate approximately 2 x 10 ^ 10 demand forecasts 274 each day to derive the optimal order volume for the next delivery cycle (e.g., three days).

Supply chain models 276 of database 134 comprise characteristics of a supply chain setup to deliver the customer expectations of a particular customer business model. These characteristics may comprise differentiating factors, such as, for example, MTO (Make-to-Order), ETO (Engineer-to-Order), or MTS (Make-to-Stock). However, supply chain models 276 may also comprise characteristics that specify the supply chain structure in even more detail, including, for example, specifying the type of collaboration with the customer (e.g., Vendor-Managed Inventory (VMI)), from where products may be sourced, and how products may be allocated, shipped, or paid for by particular customers. Each of these characteristics may lead to a different supply chain model. Prediction models 278 comprise one or more of the trained models used by planning and execution system 130 for predicting, among other variables, pricing, targeting, or retail volume, such as, for example, a forecasted demand volume for one or more products at one or more stores of one or more retailers based on the prices of the one or more products.

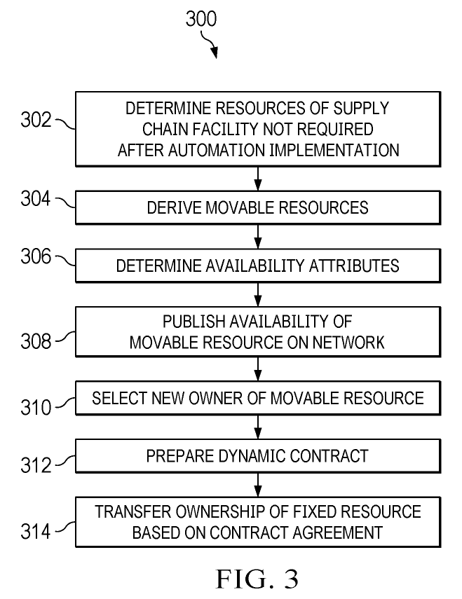

FIG. 3 illustrates example method 300 for movable resource balancing, in accordance with an embodiment. Method 300 may be performed by a movable resource balancing system, such as movable resource balancing system 110 of FIG. 1. Method 300 proceeds by one or more activities, which although described in a particular order, may be performed in one or more permutations, combinations, orders, or repetitions, according to particular needs.

At activity 302, AI module 204 of movable resource balancing system 110 determines resources of a supply chain facility which are not required after a planned automation implementation. Availability of movable resources that occur for any reason, such as, for example, an implementation of automation, a downsizing of one or more operations, a divestiture of one or more movable assets, a surplus of one or more movable resources, and/or the like. In embodiments, the one or more resources which are not required may comprise any kind of movable resource and/or asset which may be deployed, such as, for example, movable equipment, movable fixtures, robots, computer numerical control (CNC) machines, tooling, scaffolding, mobile construction equipment, and/or the like. According to some embodiments, a movable resource may comprise any movable resource that is not used per se in a supply chain, such as, for example, movable resources used in an entertainment venue (e.g., chairs, tables and accoutrements for a wedding reception and/or party, etc.), movable resources used in a medical facility (e.g., diagnostic equipment, hospital beds, etc.), movable resources used in an educational facility (e.g., projection equipment, screens, educational cut-away displays, etc.), and the like.

At activity 304, AI module 204 derives movable resources which may be used within supply chain network 100. In embodiments, the movable resources may comprise any usable resource that has a utility, for example, based on a condition of a movable resource (e.g., not requiring repair), power requirements of a movable resource (e.g., electrical vs. standalone power, voltage required, etc.), a mobility of a movable resource (e.g., self propelled, towable, requires disassembly to be moved etc.), a capacity and/or capability of a movable resource (e.g., swing of a CNC lathe, weight carrying capacity of movable shelves, carrying capacity of a mobile robot and/or AGV, etc.), and the like.

At activity 306, AI module 204 determines availability attributes of the derived resources. According to embodiments, the availability attributes may comprise any attribute describing and/or characterizing availability of a movable resource, such as, for example, one or more dates of availability, one or more locations of a movable resource, a cost and/or price of a movable resource, and the like. At activity 308, movable resource balancing module 202 of movable resource balancing system 110 publishes availability of the movable resource on a network. In embodiments, movable resource balancing module 202 may publish the availability of the movable resource on an internet portal that may be accessed by any party that seeks to acquire one or more movable resources. Embodiments contemplate that the network may comprise a network internal to a company or a network that is available to more than one firm, such as, for example, on the internet and/or on a single global network.

At activity 310, matching module 208 of movable resource balancing system 110 selects a new owner of the movable resource. According to embodiments, matching module 208 may select the new owner of the movable resource by providing one or more mechanisms for determining which new owner is to acquire the movable resource, such as, for example, by providing a request-for-quote (RFQ) process, by a first-come-first-served process (e.g., a first party to inquire about a movable resource has the movable resource allocated to them), a bidding process, and/or the like.

At activity 312, AI module 204 prepares a dynamic contract. In embodiments, the dynamic contract may comprise one or more terms for a contract for the movable resource, including any kind of agreement for transmitting ownership of a movable resource, such as, for example, a lease contract, a sales contract, a smart contract, and/or the like. The dynamic contract may also comprise a template that may be edited and/or modified. Embodiments contemplate that AI module 204 may utilize NLP module 206 of movable resource balancing system 110 to prepare the contract, as disclosed above.

At activity 314, movable resource balancing module 202 transfers ownership of the movable resource based on the contract agreement. According to embodiments, AI module 204 may utilize NLP module 206 to analyze one or more terms that denote a transferring of ownership and/or possession of the movable resource, such as, for example, natural language specifying that a new party acquiring a movable resource may take possession of the movable resource as of a certain date, that a new party may be required to transact funds for renting, leasing, and/or purchasing the movable resource, and/or the like, which movable resource balancing module 202 may utilize to transfer the ownership.

Consider the following example to demonstrate the operation of the systems and methods disclosed herein, wherein company A is implementing AI robots in a warehouse to replace automated guided vehicles (AGVs). When the automation is fully implemented, the warehouse is to no longer use any of the current fleet of AGVs. At the same time that Company A is implementing their automation, Company B is in the process of acquiring two small warehouses in the same area due to a forecasted increase in demand. In this example, Company A updates movable resource balancing system 110 via user interface module 210 with availability information regarding the AGVs they plan to surplus. The availability information includes the time frame the AGVs will become available according to the automation implementation, which requires forty-five days, as well as the type of AGV and features of each AGV. Movable resource balancing system 110 publishes the availability information on a single global network provided by movable resource balancing system 110 which Company B may also access. As soon as the AGV availability information is published, a supply chain planner working for Company B receives a notification that surplus AGVs will soon be available. Part of the notification provided by movable resource balancing system 110 further includes prices and terms as part of a draft contract for purchasing the surplus AGVs, which enables efficient transfer of the AGVs without Company A having to incur any storage costs associated with the AGVs and without the significant outlay associated with purchasing new AGVs for Company B.

Reference in the foregoing specification to “one embodiment”, “an embodiment”, or “some embodiments” means that a particular feature, structure, or characteristic described in connection with the embodiment is included in at least one embodiment of the invention. The appearances of the phrase “in one embodiment” in various places in the specification are not necessarily all referring to the same embodiment.

While the exemplary embodiments have been illustrated and described, it will be understood that various changes and modifications to the foregoing embodiments may become apparent to those skilled in the art without departing from the spirit and scope of the present invention.

What is claimed is:

1. A system for movable resource balancing, comprising:
a computer comprising a processor and memory and configured to:
determine one or more movable resources of a supply chain facility which are not required after a planned automation implementation;
derive at least one movable resource which may be used within a supply chain network;
determine availability attributes of the at least one movable resource;
publish availability of the at least one movable resource on a network;
select a new owner of the at least one movable resource;
prepare a dynamic contract; and
transfer ownership of the at least one movable resource based on the dynamic contract.

2. The system of claim 1, wherein the at least one movable resource comprises one or more of:
movable equipment, movable fixtures, robots, computer numerical control machines, tooling, scaffolding and mobile construction equipment.

3. The system of claim 1, wherein the availability attributes comprise one or more of:
one or more dates of availability, one or more locations, and a price.

4. The system of claim 1, wherein the availability is published on an internet portal.

5. The system of claim 1, wherein a new owner of the at least one movable resource is selected through a request-for-quote process.

6. The system of claim 1, wherein the dynamic contract comprises one or more terms.

7. The system of claim 1, wherein the dynamic contract comprises a compensation mechanism for utilization of the at least one movable resource.

8. A method for movable resource balancing, comprising:
determining, by a computer comprising a processor and memory, one or more resources of a supply chain facility which are not required after a planned automation implementation;
deriving, by the computer, at least one movable resource which may be used within a supply chain network;
determining, by the computer, availability attributes of the at least one movable resource;
publishing, by the computer, availability of the at least one movable resource on a network;
selecting, by the computer, a new owner of the at least one movable resource;
preparing, by the computer, a dynamic contract; and
transferring, by the computer, ownership of the at least one movable resource based on the dynamic contract.

9. The method of claim 8, wherein the at least one movable resource comprises one or more of:
movable equipment, movable fixtures, robots, computer numerical control machines, tooling, scaffolding and mobile construction equipment.

10. The method of claim 8, wherein the availability attributes comprise one or more of: one or more dates of availability, one or more locations, and a price.

11. The method of claim 8, wherein the availability is published on an internet portal.

12. The method of claim 8, wherein a new owner of the at least one movable resource is selected through a request-for-quote process.

13. The method of claim 8, wherein the dynamic contract comprises one or more terms.

14. The method of claim 8, wherein the dynamic contract comprises a compensation mechanism for utilization of the at least one movable resource.

15. A non-transitory computer-readable medium embodied with software for movable resource balancing, the software when executed is configured to:
determine one or more resources of a supply chain facility which are not required after a planned automation implementation;
derive at least one movable resource which may be used within a supply chain network;
determine availability attributes of the at least one movable resource;
publish availability of the at least one movable resource on a network;
select a new owner of the at least one movable resource;
prepare a dynamic contract; and
transfer ownership of the at least one movable resource based on the dynamic contract.

16. The non-transitory computer-readable medium of claim 15, wherein the at least one movable resource comprises one or more of:
movable equipment, movable fixtures, robots, computer numerical control machines, tooling, scaffolding and mobile construction equipment.

17. The non-transitory computer-readable medium of claim 15, wherein the availability attributes comprise one or more of:
one or more dates of availability, one or more locations, and a price.

18. The non-transitory computer-readable medium of claim 15, wherein the availability is published on an internet portal.

19. The non-transitory computer-readable medium of claim 15, wherein the new owner is selected through a request-for-quote process.

20. The non-transitory computer-readable medium of claim 15, wherein the dynamic contract comprises one or more terms.
